(19) United States
(12) Patent Application Publication
(10) Pub. No.: US 2020/0326030 A1
(43) Pub. Date: Oct. 15, 2020

(54) Accessory for Attachment to a Portable Interactive Programmable Device

(71) Applicants: Sharjeel Surani, Frisco, TX (US); Louis Fabec, Suwanee, GA (US)

(72) Inventors: Sharjeel Surani, Frisco, TX (US); Louis Fabec, Suwanee, GA (US)

(21) Appl. No.: 16/795,222

(22) Filed: Feb. 19, 2020

Related U.S. Application Data
(60) Provisional application No. 62/807,318, filed on Feb. 19, 2019.

(51) Int. Cl. F16M 11/12; G06F 1/16

(52) U.S. Cl. CPC F16M 11/12; G06F 1/1632

(57) ABSTRACT

An accessory for attachment to a portable interactive programmable device is disclosed. In one embodiment, the accessory includes a base member configured to engage a portion of the portable interactive programmable device. A flexured body member is coupled to the base member and is capable of extending generally along a generally perpendicular axis from the base member and retracting generally along the axis toward the base member. The flexured body member, when extended, has terminal opposition surfaces in which digits hold the flexured body member therebetween. Also, the flexured body member, when extended, is approximately a digit width in axial length, with a vertical profile.

### PRIORITY STATEMENT & CROSS-REFERENCE TO RELATED APPLICATIONS

This application claims priority from co-pending U.S. Patent Application No. 62/807,318, entitled “Accessory for Attachment to a Portable Interactive Programmable Device” and filed on Feb. 19, 2019, in the names of Sharjeel Surani, et al.; which is hereby incorporated by reference, in entirety, for all purposes.

### TECHNICAL FIELD OF THE INVENTION

This invention relates, in general, to cellular phone accessories and the like and, in particular, to an accessory for attachment to a portable interactive programmable device.

### BACKGROUND OF THE INVENTION

Cellular phones and other handheld mobile devices continue to increase in size as users demand larger and larger screens. As cellular phones and other handheld mobile devices have increased in size, many users have found the larger screens harder to navigate with one hand. A growing need has emerged for new accessories for cellular phones and other handheld mobile devices that provide suitable grip.

### SUMMARY OF THE INVENTION

It would be advantageous to achieve an accessory for attachment to a portable interactive programmable device that would improve upon existing limitations in functionality with respect to handling and navigation with a single hand. It would also be desirable to enable a mechanical and materials science-based solution that would provide enhanced performance and improved usability. To better address one or more of these concerns, an accessory for attachment to a portable interactive programmable device, such as a smart phone or smart phone with a case, is disclosed. In one embodiment, the accessory includes a base member configured to engage a portion of the portable interactive programmable device. A flexured body member is coupled to the base member and is capable of extending generally along a generally perpendicular axis from the base member and retracting generally along the axis toward the base member. The flexured body member, when extended, has terminal opposition surfaces in which digits hold the flexured body member therebetween. Also, the flexured body member, when extended, is approximately a digit width in axial length, with a vertical profile.

In another aspect, an accessory for attachment to a portable interactive programmable device includes a protective case member rather than a base member. A flexured body member is coupled to the protective case member and is capable of extending generally along a generally perpendicular axis from the protective case member and retracting generally along the axis toward the protective case member. The flexured body member, when extended, has terminal opposition surfaces in which digits hold the flexured body member therebetween. Also, the flexured body member, when extended, is approximately a digit width in axial length, with a vertical profile. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a side perspective view illustrating one embodiment of an accessory for attachment to a portable interactive programmable device according to the teachings presented herein being utilized;

FIG. 2 is a side perspective view illustrating another embodiment of the accessory for attachment to a portable interactive programmable device depicted in FIG. 1 being utilized;

FIG. 3 is a top plan view illustrating the accessory depicted FIG. 1;

FIG. 4 is a bottom plan view illustrating the accessory depicted in FIG. 1;

FIG. 5 is a side elevation view of the accessory depicted in FIG. 1 extended in an elongated orientation;

FIG. 6 is a side elevation view of the accessory depicted in FIG. 1 retracted in a collapsed orientation;

FIG. 7 is a side elevation view of the accessory depicted in FIG. 1 positioned in a clam-shell orientation;

FIG. 8 is a side elevation view, in section, of the accessory depicted in FIG. 5;

FIG. 9 is a side elevation view, in section, of the accessory depicted in FIG. 6;

FIG. 10 is a side elevation view, in section, of another embodiment of an accessory for attachment to a portable interactive programmable device according to the teachings presented herein being utilized, extended in an elongated orientation;

FIG. 11 is a side elevation view of an accessory depicted in FIG. 10, retracted in a collapsed orientation; and

FIG. 12 is a side elevation of still another embodiment of an accessory according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

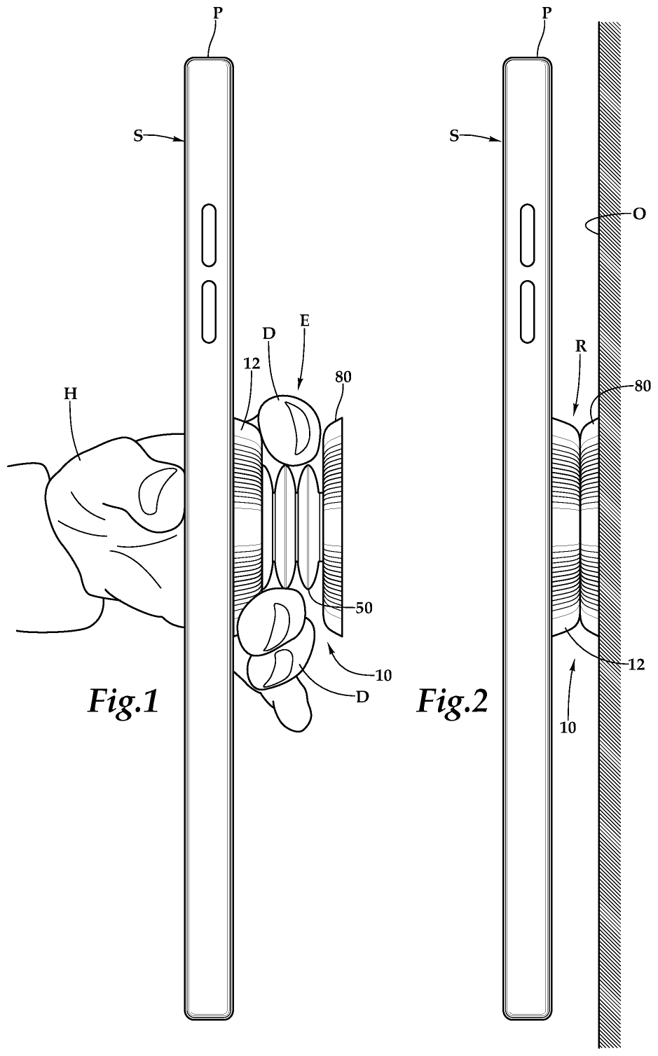

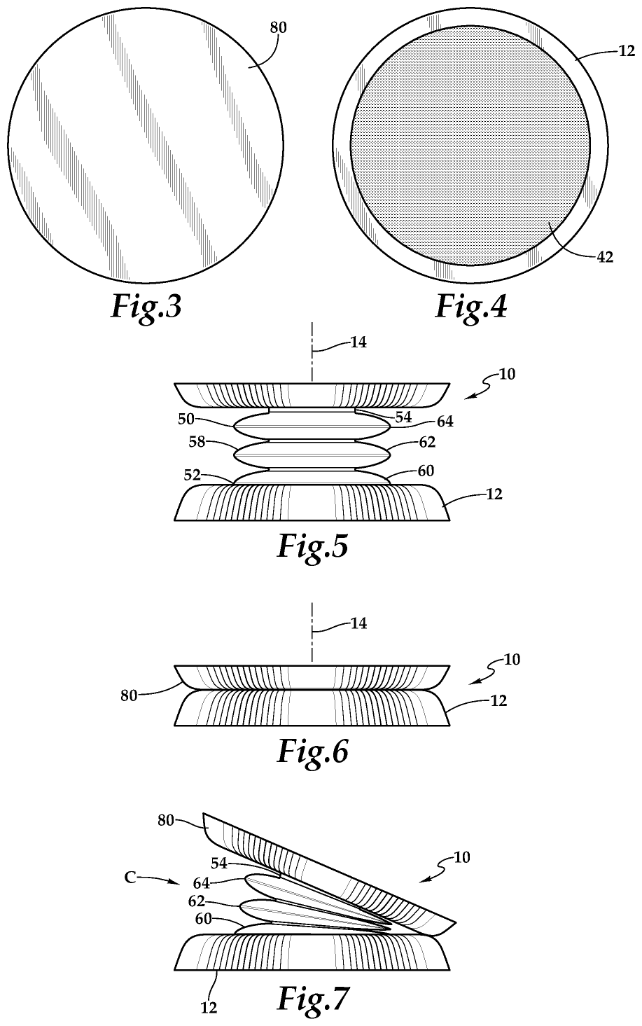

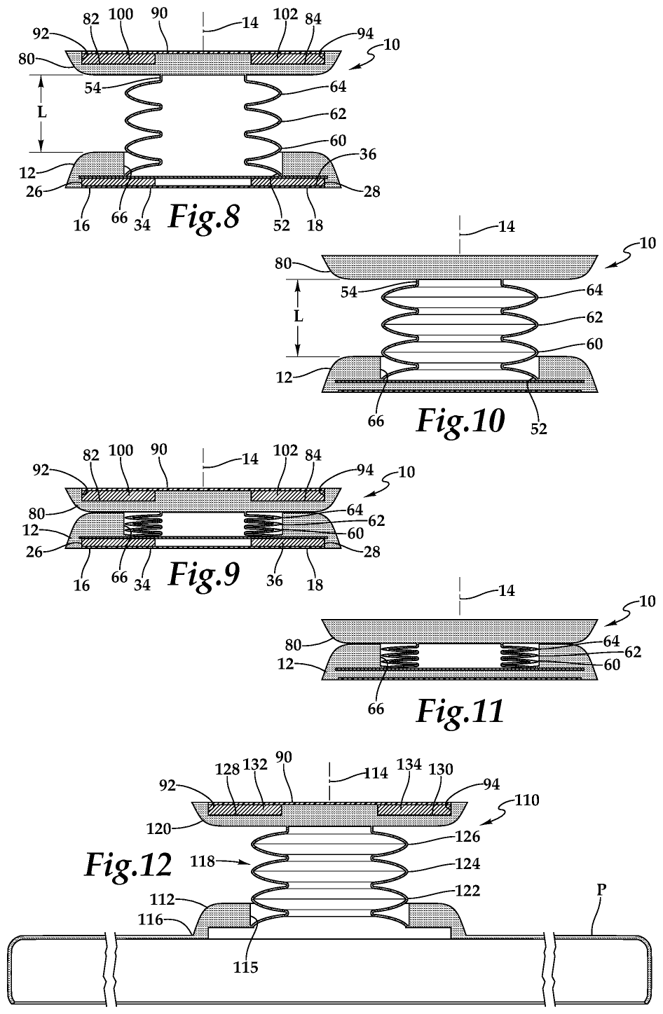

Referring initially to FIG. 1 through FIG. 9, therein is depicted one embodiment of an accessory for attachment to a portable interactive programmable device, which is schematically illustrated and designated 10. As shown, the accessory 10 is attached to a smart phone S. It should be appreciated that the portable interactive programmable device may be any type of electronic device such as a smart phone or a tablet computer, for example. Further, as illustrated, the accessory 10 may be secured to a protective case member P associated with the smart phone S. In one embodiment, the accessory 10 includes a base member 12 configured to engage a portion of the protective case member P of the smart phone S. The base member 12 has an axis 14 perpendicular to the protective case member P of the smart phone S. As shown, the base member 12 includes chambers 16, 18 defined by cover 24 and respective slots 26, 28. Metal plate 34 and metal plate 36 are respectively located within the chambers 16, 18. It should be appreciated that any number and configuration of chambers may be present within the base member 12. Additionally, any combination of magnetic plates and metal plates or exclusively magnetic plates or exclusively metal plates may be utilized. In one implementation, an adhesive layer 42 is located on the base member 12 to provide adhesion to the smart phone S or protective case member P, for example.

A flexured body member 50 includes ends 52, 54 and is coupled to the base member 12 at the end 52. The flexured body member 50 is capable of extending generally along the axis 14 from the base member 12 and retracting generally along the axis 14 toward the base member 12. The flexured body member 50, extended, includes terminal opposition surfaces 56, 58 in which digits D of a hand H hold the flexured body member 50 therebetween. In one embodiment, the flexured body member 50, extended, is approximately a digit width in axial length L at the axis 14 from the end 52 to the end 54.

As shown, the flexure body member 50 may have a vertical profile from the end 52 to the end 54 such that the end 52 of the flexured body member 50 aligns with the end 54 of the flexure body member 50. The flexured body member 50 may include segments 60, 62, 64 that provide folding sections having walls and hinges or bendable portions. Vents (not shown) positioned on the segments 60, 62, 64 provide for the movement of air during expansion and contraction. In one implementation, the segment 64 may collapse and expand from the segment 62, which in turn collapses and expands from the segment 60. A recess 66 is positioned in the base member 12 and the recess 66 is sized and configured to accept the flexured body member 50 when the base member 12 and an end member 80 have a collapsed orientation therebetween, as shown in FIGS. 6 and 9, for example. As shown in FIGS. 6 and 9, the recess accepts the segments 60, 62, 64 therein.

Referring again to FIG. 1 through FIG. 9, the end member 80 is disposed at the end 54 of the flexured body member 50. The end member includes chambers 82, 84 defined by cover 90 and respective slots 92, 94. A metal plate 102 and metal plate 106 are respectively located within the chambers 82, 84. It should be appreciated that any number and configuration of chambers may be present within the end member 80. Additionally, any combination of magnets and metal plates or exclusively magnets or exclusively metal plates may be utilized. Similarly, with respect to the base member 12 and the end member 80, one side may have magnets and metal plates while the other side has no magnets or metal plates.

The accessory provides several positions. With respect to FIG. 7, a semi-locked position may exist where a selectively releasable magnetic coupling between the base member 12 and the end member 80 provides a clam-shell orientation therebetween, as shown by element C. More specifically, the metal plate 36 at the base member 12 may be magnetically coupled to the magnetic plate 102 at the end member 80. Also, with respect to FIGS. 6 and 9, a locked position, as shown by element R, may exist where a selectively releasable magnetic coupling between the base member 12 and the end member 80 provides a collapsed orientation therebetween. As further noted, the accessory 102 may have an extended position as shown by element E.

In operation, the accessory 10 for attachment to a portable interactive programmable device, such as a smart phone or tablet computer, may be utilized in an extended position E to provide for increased functionality with respect to handling and navigation with a single hand. Also, the accessory 10 may be collapsed in a retracted position R to provide an improved form function with respect to storage and placement. In particular, in embodiments where the accessory 10 has magnetic plates and metal plates positioned at the base member 12 and the end member 80, the accessory 10 may interact with a wide variety of surroundings. By way of example and not by way of limitation, with the appropriate configuration of magnetic plates and metal plates at the base member 12 and the end member 80, the accessory 10 may be releasably attached to a protective case member P and, on the other side, releasably attached to a variety of metallic and metal surfaces.

Referring now to FIG. 10 and FIG. 11, as previously mentioned, any combination of magnets and metal plates or exclusively magnets or exclusively metal plates may be utilized with the accessory 10. Similarly, with respect to the base member 12 and the end member 80, one side may have magnets and metal plates while the other side has no magnets or metal plates. In the embodiment shown in FIGS. 10 and 11, no chambers or magnets or metal plates are present in the base member 12 and the end member 80 of the accessory 10.

Referring now to FIG. 12, in one embodiment of an accessory 110 for attachment to a portable interactive programmable device, the accessory 110 is incorporated with a protective case member P configured to engage a portion of the portable interactive programmable device, such as a smart phone or a tablet computer. Similar to previously discussed embodiments, the base member 112 has an axis 114 perpendicular thereto. The base member 112 includes a recess 115 and may be integrally coupled to the protective case member P as shown by reference numeral 116. A flexured body member 118 is coupled to the base member 112 as well as an end member 120. The flexured body member 118 is capable of extending generally along the axis 114 from the base member 112 and retracting generally along the axis 114 toward the base member 112. The flexured body member 118, extended, has terminal opposition surfaces in which digits hold the body member therebetween. As shown, the flexured body member 118 has segments 122, 124, 126. In one implementation, the flexured body member 118, extended, is approximately a digit width in axial length. The end member 120 includes at least one chamber for a combination of metal plates and magnetic plates. As shown, the end member 120 includes chambers 128, 130 respectively including a magnetic plate 132 and magnetic plate 134. It should be appreciated that any form of body member 116 may be utilized with this embodiment where the base member 112 is incorporated into the protective case member P.

The order of execution or performance of the methods and techniques illustrated and described herein is not essential, unless otherwise specified. That is, elements of the methods and techniques may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

1. An accessory for attachment to a portable interactive programmable device, the accessory comprising:
a base member configured to engage a portion of the portable interactive programmable device, the base member having an axis perpendicular thereto, the base member including a first chamber;
a flexured body member having a first end and a second end, the flexured body member coupled to the base member at the first end, the flexured body member capable of extending generally along the axis from the base member and retracting generally along the axis toward the base member;
the flexured body member, extended, having terminal opposition surfaces in which digits hold the flexured body member therebetween, the flexured body member, extended, being approximately a digit width in axial length;
an end member disposed at the second end of the flexured body member, the end member including a second chamber; and
each of the first chamber and the second chamber including one of a metal plate and a magnetic plate.

2. The accessory as recited in claim 1, wherein the base member further comprises a third chamber.

3. The accessory as recited in claim 2, wherein the third chamber further comprises a metal plate.

4. The accessory as recited in claim 2, wherein the third chamber further comprises a magnetic plate.

5. The accessory as recited in claim 1, wherein the end member further comprises a fourth chamber.

6. The accessory as recited in claim 5, wherein the fourth chamber further comprises a metal plate.

7. The accessory as recited in claim 5, wherein the fourth chamber further comprises a magnetic plate.

8. The accessory as recited in claim 1, wherein the portable interactive programmable device further comprises a device selected from the group consisting of smart phones and tablet computers.

9. The accessory as recited in claim 1, wherein the flexured body member further comprises a vertical profile.

10. The accessory as recited in claim 1, wherein the first chamber includes a metal plate and the second chamber includes a magnetic plate.

11. The accessory as recited in claim 10, further comprising a semi-locked position wherein a selectively releasable magnetic coupling between the base member and the end member provides a clam-shell orientation therebetween.

12. The accessory as recited in claim 10, further comprising a locked position wherein a selectively releasable magnetic coupling between the base member and the end member provides a collapsed orientation therebetween.

13. The accessory as recited in claim 1, wherein the base member further comprises a recess configured to accept the flexured body member when the base member and the end member have a collapsed orientation therebetween.

14. The accessory as recited in claim 1, wherein the first end of the flexured body member aligns with the second end of the flexured body member.

15. An accessory for attachment to a portable interactive programmable device, the accessory comprising:
a base member configured to engage a portion of the portable interactive programmable device, the base member having an axis perpendicular thereto, the base member including a first chamber;
a flexured body member having a first end and a second end, the flexured body member coupled to the base member at the first end, the flexured body member capable of extending generally along the axis from the base member and retracting generally along the axis toward the base member;
the flexured body member, extended, having terminal opposition surfaces in which digits hold the flexured body member therebetween, the flexured body member, extended, being approximately a digit width in axial length;
the first end of the flexured body member aligns with the second end of the flexured body member to define a vertical profile;
an end member disposed at the second end of the flexured body member, the end member including a second chamber; and
each of the first chamber and the second chamber including one of a metal plate and a magnetic plate.

16. The accessory as recited in claim 15, wherein the first chamber includes a metal plate and the second chamber includes a magnetic plate.

17. The accessory as recited in claim 16, further comprising a semi-locked position wherein a selectively releasable magnetic coupling between the base member and the end member provides a clam-shell orientation therebetween.

18. The accessory as recited in claim 16, further comprising a locked position wherein a selectively releasable magnetic coupling between the base member and the end member provides a collapsed orientation therebetween.

19. An accessory for attachment to a portable interactive programmable device, the accessory comprising:
a base member configured to engage a portion of the portable interactive programmable device, the base member having an axis perpendicular thereto;
a flexured body member having a first end and a second end, the flexured body member coupled to the base member at the first end, the flexured body member capable of extending generally along the axis from the base member and retracting generally along the axis toward the base member;
the flexured body member, extended, having terminal opposition surfaces in which digits hold the flexured body member therebetween, the flexured body member, extended, being approximately a digit width in axial length;
the first end of the flexured body member aligns with the second end of the flexured body member to define a vertical profile;
an end member disposed at the second end of the flexured body member; and
a recess in the base member, the recess configured to accept the flexured body member when the base member and the end member have a collapsed orientation therebetween.

20. The accessory as recited in claim 19, further comprising a semi-locked position wherein a selectively releasable magnetic coupling between the base member and the end member provides a clam-shell orientation therebetween.
